(19) United States
(12) Patent Application Publication
(10) Pub. No.: US 2006/0250686 A1
(43) Pub. Date: Nov. 9, 2006

(54) Optical microscope and method for obtaining an optical image

(75) Inventors: Yuval Garini, Delft (NL); Ian Theodore Young, Delft (NL)

Correspondence Address: PEACOCK MYERS, P.C., 201 THIRD STREET, N.W., SUITE 1340, ALBUQUERQUE, NM, 87102, US

(73) Assignee: Technische Universiteit Delft, BL Delft (NL)

(21) Appl. No.: 11/393,523

(22) Filed: Mar. 29, 2006

Related U.S. Application Data
(63) Continuation-in-part of application No. PCT/NL04/00671, filed on Sep. 29, 2004.

(30) Foreign Application Priority Data
Sep. 30, 2003 (NL) 1024404

(51) Int. Cl. G02B 21/00

(52) U.S. Cl. 359/368

(57) ABSTRACT

The invention relates to an optical microscope, comprising, at least a light source, a carrier for an object to be examined, a detector for registering the illuminated object, and a light path that during operation runs substantially from the light source to the object and form the object to the detector, wherein a metallic film having a periodic hole array is placed in the light path between the light source and the object, and wherein the carrier of the object is provided with a drive to allow the same to be adjusted in the plane of the carrier, wherein the holes of the metallic thin film have a diameter that is smaller than approximately 250 nm, in that the drive is designed for adjusting the carrier for the object in an orientation perpendicular to the plane of the carrier, and in that a processing device is provided that is connected with the detector for constructing a three-dimensional image of the object.

The invention relates to an optical microscope, comprising at least a light source, a carrier for an object to be examined, a detector for registering the illuminated object, and a light path that during operation runs substantially from the light source to the object and from the object to the detector, wherein a metallic thin film having a periodic hole array is placed in the light path between the light source and the object, and the carrier of the object is provided with a drive to allow the same to be adjusted in the plane of the carrier.

The invention also relates to a method for obtaining an optical image of an object by using a light source for illuminating and/or passing light through the object, and a detector for registering light emitted by the object, and wherein a metallic thin film having a periodic hole array is placed between the light source and the object, and wherein the object is moved in a plane that runs substantially parallel with the metallic thin film. The metallic thin film will hereafter also be referred to as metallic plate.

Such an optical microscope and method based on detection in the near field are known from US 2003/0147083 as well as from U.S. Pat. No. 4,662,747. Performing measurements on the thickness of objects, or in general performing measurements on thicker objects, is here not possible.

Such a microscope and method based on a confocal measurement are known from US 2003/0030794. The resolution is limited.

Such an optical microscope and method are also known from the American patent application Ser. No. 09/981,280, published under number US 2002/0056816 A1.

From this publication a so-called surface plasmon enhanced microscopy apparatus is known, wherein an object is placed above a lens of the microscope, and wherein a multiple fibre bundle, i.e. a glass fibre probe provided with several exits, is brought very close to the object in order to illuminate it. For the illumination any suitable light source may be used, such as a pumped laser, a light emitting diode, an arc lamp or another generator for white light, which after passing a filter and a polariser is brought into the fibre bundle. The light exiting the fibre bundle at the end near the object produces a plurality of light spots projected on the object which, employing the optics normally used for this purpose, are perceived and detected in the far-field by a detector designed as a cooled CCD. The object is placed on a carrier embodied as a table that is adjustable in the horizontal plane. This allows the object to be adjusted in the horizontal xy-orientation such that the entire surface of the object can be brought into the frame.

Although in the publication a multiple fibre bundle is used to illuminate the object, it is also possible to obtain the multiple light beam referred to in this publication by using a metallic thin film. However, the construction of the metallic thin film referred to in this publication is rather intricate, with different metals being applied at the lower and upper side of the film.

Furthermore the publication mentions to apply a 3-axis translation stage as carrier for the object, and than the disclosed surface plasmon entranced microscope can be used to reconstruct a three-dimensional data set of protein locations of the investigated object.

It is an object of the invention to provide a method and an optical microscope with which it is possible to obtain quickly high-resolution three-dimensional images of objects. High resolution is understood to mean better than 200 nm.

In a first aspect of the invention, the proposed method is characterised in that the processing device connected with the detector should be designed for processing a spread function of every illumination spot on the object.

A rapid image acquisition is then possible since the holes in the metallic thin film may then be placed more closely together.

An effective aid for obtaining high object resolutions is to allow the processing device to deconvolute the spread functions of the illumination spots on the object.

In a particular embodiment of the optical microscope according to the invention, the three-dimensional imaging of the object can be performed effectively due to the drive being designed for a) an adjustment covering the entire range in the plane of the carrier, followed by b; a stepwise adjustment perpendicular to the plane of the carrier, whereafter c) a further adjustment covering the entire range in the plane of the carrier takes place, and the adjustments a, b and c being repeated until the object is completely illuminated.

In an alternative embodiment, the three-dimensional imaging can be effectively achieved due to the optical microscope being characterised in that the drive is designed for d) an adjustment covering the entire range perpendicular to the plane of the carrier, followed by e) an adjustment in the plane of the carrier, whereafter f) a further adjustment covering the entire range perpendicular to the plane of the carrier takes place, and in that the adjustments d, e and f are repeated until the object is completely illuminated.

In the method according to the invention it is possible that the object is stationary and the metallic thin film moves. In the case where the metallic gate is movable, the device comprising the same may be set up to be stationary. It is also conceivable for the object to be set up to be stationary while the metallic plate including the apparatus comprising the same, is set up to be movable.

Nonetheless, it is more effective for the device and the metallic plate to be set up to be stationary and that the object for the purpose of three-dimensional imaging is adjusted in the device.

The optical microscope has a metallic thin film with holes whose diameter is smaller than approximately 250 nm. The thin film is a homogeneous and single thin film. The light exiting through the periodic hole array of this metallic thin film has a favourably small spread. It allows the optical microscope to be constructed simply and to be made available at low costs. Moreover, the microscope possesses favourable confocal properties.

Herein below, the invention will be further elucidated by way of a non-limiting exemplary embodiment and with reference to the drawing.

In the drawing:

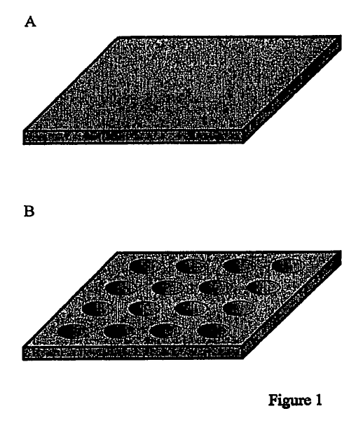

FIG. 1 shows a metallic thin film (FIG. 1A) and a metallic thin film having a periodic hole array (FIG. 1B),

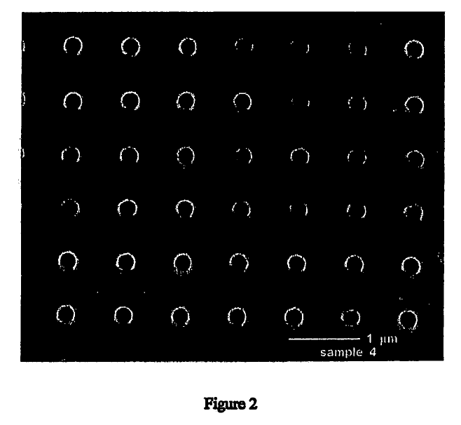

FIG. 2 shows a much enlarged typical example of a metallic thin film having a periodic hole array in accordance with the invention,

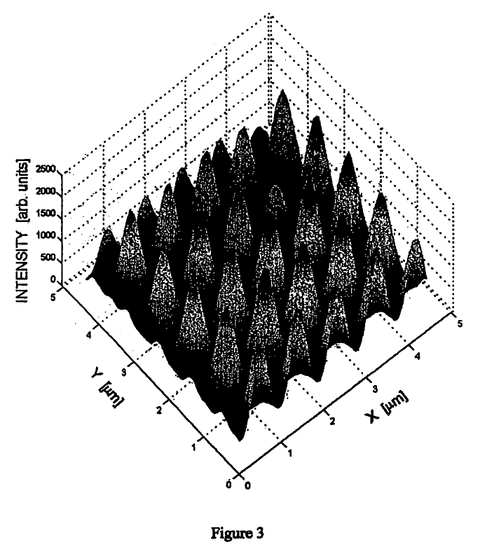

FIG. 3 shows a 3-D image of the detected intensity distribution of light coming through the metallic thin film in accordance with FIG. 2,

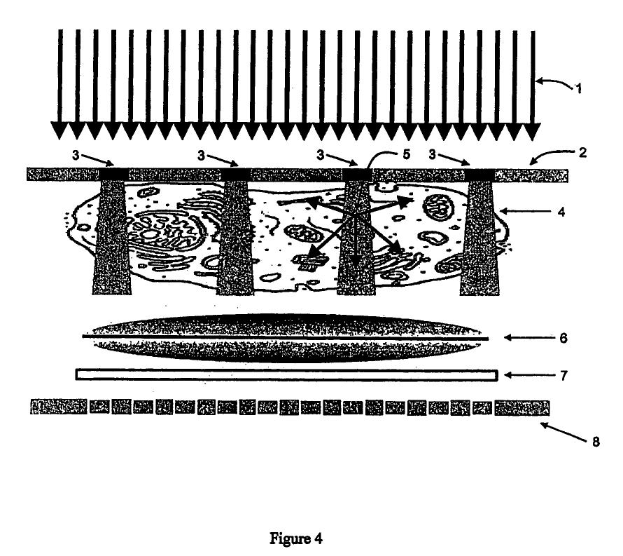

FIG. 4 shows a schematic illustration of the optical microscope according to the invention,

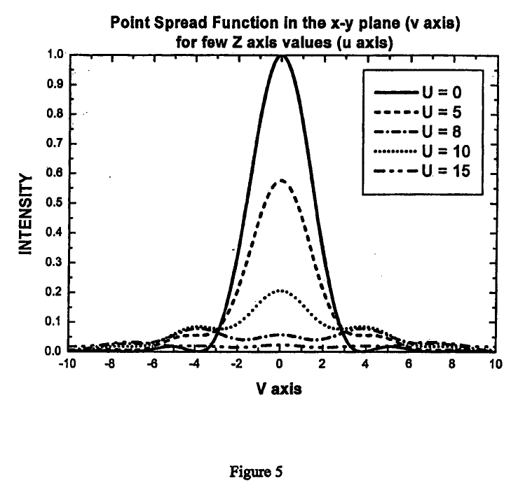

FIG. 5 shows some spread functions as obtained by using the metallic thin film in accordance with FIG. 2 in an optical microscope according to the invention,

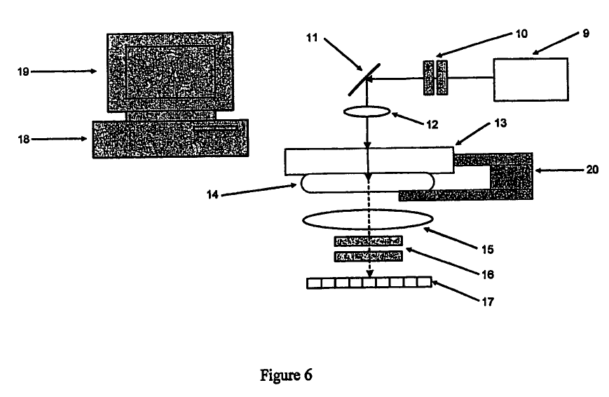

FIG. 6 shows a second schematic illustration of the optical microscope according to the invention.

FIG. 1A shows a portion of a metallic thin film, which has a thickness in the range of 50 nm to 5 μm. FIG. 1B shows the metallic thin film of FIG. 1A, provided with a periodic hole array.

In reality, the distances between the holes of such a metallic thin film comprising a periodic hole array are approximately 1 μm, as shown in FIG. 2. The metallic thin film shown in this FIG. 2 is fabricated from 600 nm thick silver applied on a glass substrate by vapour deposition, and wherein the holes have a diameter that is smaller than approximately 250 nm, in this example approximately 200 nm, and the distance centre-to-centre in the x and y orientation is 800 nm. A smallest diameter of the holes may measure, for example, approximately 10 nm. For the intended use in an optical microscope the metallic thin film may be any suitable metal, however silver, aluminium, gold or the like, are preferred.

Illumination of an object using the metallic thin film shown in FIG. 2 provides exceptional results. A high percentage of the light that reaches the holes passes through them and, with respect to its spectral composition, is influenced by the metallic thin film. Moreover, in a suitable embodiment of the metallic thin film, the light passing through it has a very small diffraction angle.

The light emitted by the object illuminated through the metallic thin film, can be detected using standard far-field optics employing, for example, an objective disposed at a suitable distance from the object to be studied. The light can then be detected with a CCD camera or the like. If the distances between the holes of the metallic thin film are great enough, so that the far-field diffraction of two neighboring illuminated spots on the object do not overlap, it is possible to simply use the signal detected with the CCD camera for providing an image of the object. The entire object can be brought into the frame by adjusting the same in the usual manner in the xy orientation, until complete illumination and imaging of the surface is realised.

To elucidate, FIG. 3 shows a three-dimensional illustration of the light intensity measured over a limited area of the metallic thin film, if the same is being used for the illumination of an object in the manner described above.

FIG. 4 shows the principle of operation of the optical microscope according to the invention. Light 1 from a suitable light source falls on a metallic thin film 2, which is provided with a periodic hole array. The light shining through the holes 3 of the metallic thin film 2 has a low level of diffraction, for example, approximately 6°. The object 4 to be studied is placed in the light path, as close as possible behind the metallic thin film 2. The light shining through the holes 3 is able to illuminate fluorescent points of the object 4, shown in the Figure for a single point 5.

In the light path behind the object 4, conventional optics are provided for detection in the far field of the light emitted by the object 4. These optics may include, for example, a lens 6, a filter 7 and a CCD 8, or another suitable detector.

The light emitted by the fluorescent point 5 of the object 4, will be detected by the CCD 8 in the form of a spread function as shown in FIG. 5. FIG. 5 shows this spread function for various distances “U” of the metallic thin film 2 in relation to the object 4. The distance “U” clearly influences the peak of the spread curve, as well as the degree of spread in the plane of the CCD.

FIG. 6 shows a schematic illustration of the optical microscope according to the invention. Via optics 10, 11, 12 light from a light source 9 is directed to a metallic thin film 13 provided with a periodic hole array as explained with reference to the FIGS. 1, 2, 3 and 4. The light passing through the metallic thin film 13 illuminates an object 14 to be studied. The light, which as a consequence is emitted from said object 14, is directed via conventional optics 15, 16 to and detected by a detector 17. This detector 17 may, for example, be a CCD camera. The light detected by the detector 17 is processed in a processing device, for example, a computer 18 provided with a VDU for showing the reconstructed image of the object 14.

The metallic thin plate 13 is coupled with a drive unit 20 for adjusting the metallic thin plate 13 both in the xy orientation and in the z orientation perpendicular to the xy plane, facilitating a three-dimensional adjustment of the metallic thin plate 13 and thereby an illumination of the object 14, such as to enable the processing device 18 to construct a three-dimensional image of said object 14. To this end the drive should move in the xy and z orientation in steps ranging from 5 to 500 nm.

As already explained above, it is also possible to set up the object 14 so as to be stationary and the metallic thin plate 13 so as to be movable in both the xy orientation and the z orientation. With this latter embodiment, it is also possible to set up the apparatus comprising the metallic thin plate as such to be stationary, and to make only the metallic thin plate adjustable. In that case, the processing device 18 that is connected with the detector 17 needs to make an appropriate (software) adjustment with respect to the detected light spots on the object 14. A theoretically conceivable possibility is to set up the object 14 so as to be stationary, and to set up the entire apparatus comprising the metallic thin plate 13 so as to be movable. Although this possibility is less practicable it is nevertheless mentioned, so as to render the exclusive right applicant merits fully comprehensive.

The above given explanation by way of the discussed exemplary embodiment is not limiting with respect to the appended claims. The embodiment of the optical microscope shown in FIG. 6 may be varied in many ways, without departing from the spirit of the invention as specified in the appended claims. It is, for example, possible to place the detector and the optics that serve to direct and focus fluorescent light emitted by the object on the same side as the light source. Although this means that the light output at the detector is reduced, an advantage is that in this embodiment a further improved resolution can be achieved.

What is claimed is:

1. An optical microscope, comprising at least a light source, a carrier for an object to be examined, a detector for registering the illuminated object, and a light path that during operation runs substantially from the light source to the object and from the object to the detector; and wherein
a metallic thin film having a periodic hole array is placed in the light path between the light source and the object;
the carrier of the object is provided with a drive to allow the same to be adjusted in the plane of the carrier;
the holes of the metallic thin film have a diameter that is smaller than approximately 250 nm, wherein said drive is designed for adjusting the carrier for the object in an orientation perpendicular to the plane of the carrier; and
a processing device is provided that is connected with the detector for constructing a three dimensional image of the object, wherein the processing device connected with the detector is capable of processing a spread function of every illumination spot on the object.

2. An optical microscope according to claim 1, wherein the processing device deconvolutes the spread functions of the illumination spots on the object.

3. An optical microscope according to claim 1, wherein the drive is capable of:
a) an adjustment covering the entire range in the plane of the carrier, followed by
b) a stepwise adjustment perpendicular to the plane of the carrier, whereafter
c) a further adjustment covering the entire range in the plane of the carrier takes place, and the adjustments a, b and c are repeated until the object is completely illuminated.

4. An optical microscope according to claim 1, wherein the drive is capable of:
d) an adjustment covering the entire range perpendicular to the plane of the carrier, followed by
e) an adjustment in the plane of the carrier, whereafter
f) a further adjustment covering the entire range perpendicular to the plane of the carrier takes place,
and wherein the adjustments d, e and f are repeated until the object is completely illuminated.

5. An optical microscope according to claim 1, wherein the metallic thin film is a homogeneous and single thin film.

6. A method for obtaining an optical image of an object by using a light source for illuminating and/or passing light through the object and a detector for registering light emitted by the object, and wherein
a metallic thin film having a periodic hole array is placed between the light source and the object;
the object is moved in a plane that runs substantially parallel with the metallic thin film;
the diameter of the holes in the metallic thin film is smaller than approximately 250 nm;
the object and the metallic thin film are moved away from or towards each other; and
the light registered by the detector is processed to form a three-dimensional image of the object, wherein the processing comprises calculating a spread function of every illumination spot on the object.

7. A method according to claim 6, wherein the processing comprises deconvoluting the spread functions of the illumination spots on the object.
